(19) United States
(12) Patent Application Publication
(10) Pub. No.: US 2025/0162542 A1
(43) Pub. Date: May 22, 2025

(54) DEVICE FOR CLEANING MOTOR VEHICLE SENSORS, COMPRISING SEVERAL VALVE BLOCKS MOUNTED IN SERIES

(71) Applicant: VALEO SYSTEMES D'ESSUYAGE, La Verriere (FR)

(72) Inventors: Frederic BRETAGNOL, La Verriere (FR); Marcel TREBOUET, La Verrière (FR)

(73) Assignee: VALEO SYSTEMES D'ESSUYAGE, La Verriere (FR)

(21) Appl. No.: 18/840,136

(22) PCT Filed: Feb. 1, 2023
(86) PCT No.: PCT/EP2023/052487

§ 371 Date: Aug. 21, 2024

(30) Foreign Application Priority Data
Feb. 28, 2022 (FR) FR2201732

(51) Int. Cl. B60S 1/48; B60S 1/56

(52) U.S. Cl. CPC B60S 1/481; B60S 1/56

(57) ABSTRACT

A cleaning device for cleaning motor vehicle sensors. The device includes at least one tank of cleaning liquid and several cleaning nozzles for spraying the cleaning liquid onto the various sensors to be cleaned. The device further includes a control unit configured to receive and transmit information coming from the various sensors, a main valve block configured to control the delivery of cleaning liquid to a first set of nozzles, the main valve block including a main control circuit configured to receive information coming from the control unit, and at least a first secondary valve block including a first secondary control circuit configured to receive and transmit information from/to the main valve block, the electrical connection being effected by a multiplexed electrical network.

### TECHNICAL FIELD

The invention relates to devices for cleaning motor vehicle sensors intended to be mounted on a motor vehicle.

### BACKGROUND OF THE INVENTION

Motor vehicles increasingly include sensors to assist the driving of motor vehicles, which can be subject to various types of dirt. These sensors include for example the various cameras or the distance sensors, ultrasonic sensors, radars, LIDAR sensors or rain sensors placed on the vehicle.

However, this dirt may cause certain driver assist devices to malfunction or cause a user of the vehicle to begin to experience difficulties (lack of visibility because of dirt on the windshield). It is therefore necessary to provide at least a device for cleaning these surfaces.

Conventionally, such cleaning devices comprise a tank in which cleaning liquid is stored, and a fluid distribution circuit made up of various pipes or tubes that make it possible to convey the cleaning liquid to at least one cleaning nozzle placed in front of a surface so as to spray cleaning liquid onto it (as a general rule, there are a plurality of cleaning nozzles for a plurality of surfaces).

A pump suitable for propelling cleaning liquid in the fluid distribution circuit to the cleaning nozzle is generally mounted directly on the tank. More specifically, a liquid intake tube of the pump is forced-fitted into an opening made in the tank (a seal is used to ensure that the assembly is leaktight), and the liquid discharge orifice is connected to the fluid distribution circuit.

It is also known practice to position, on the fluid distribution circuit, a cleaning-liquid distribution block (or valve block) comprising for example several valves placed between the pump and the cleaning nozzle or nozzles, it being possible for each valve to be fluidically connected to a cleaning nozzle. This valve block allows, for example, the valves to be opened selectively so that cleaning liquid is sprayed only through those cleaning nozzles that are situated facing a sensor that needs to be cleaned, while the other cleaning nozzles are kept closed. It is also possible to use the valve block as an intermediate stage level enabling maximum pressurization of part of the fluid distribution circuit situated between the pump and the distribution block so as to limit pressure drops as far as the cleaning nozzles.

It is therefore envisaged to place several cleaning-liquid distribution blocks in the fluid distribution circuit, each cleaning-liquid distribution block being fluidically connected to at least one cleaning nozzle. It is also advantageous to shift the position of these cleaning-liquid distribution blocks in order to place them as close as possible to the nozzle or nozzles to which they are connected (this makes it possible, for example, to limit pressure drops between the cleaning liquid outlet of the cleaning-liquid distribution block and the outlet for this same cleaning liquid from the connected nozzle or nozzles).

However, the profusion of distribution blocks and their placement close to the cleaning nozzles leads to an increase in the weight of electrical cables on board and in the number of electrical connections owing to the need to connect all of the fluid distribution blocks to a control unit, which results in an increase in the weight of cables on board as well as an increase in the manufacturing cost of the cleaning device. This can also lead to a sensor cleaning device that is very complex in terms of architecture.

Moreover, the sensor cleaning device is difficult to reconfigure. To be specific, if it is desired to add a cleaning-liquid distribution block, it is necessary to connect it to the control unit and reprogram the entire sensor cleaning device so that the new cleaning-liquid distribution block is recognized.

### SUMMARY OF THE INVENTION

The invention aims in particular to provide a sensor cleaning device comprising several cleaning-liquid distribution blocks of simple architecture, in which the weight of electrical cables used is low, the sensor cleaning device being easy to reconfigure.

To this end, the invention relates to a cleaning device for cleaning motor vehicle sensors intended to be mounted on a motor vehicle, the device comprising at least one tank of cleaning liquid and several cleaning nozzles for spraying the cleaning liquid onto the various sensors to be cleaned, the cleaning device being characterized in that it comprises:
a control unit configured to receive and transmit information coming from the various sensors,
a main valve block configured to control the delivery of cleaning liquid to a first set of nozzles, the main valve block comprising a main control circuit configured to receive information coming from the control unit,
at least a first secondary valve block configured to control the delivery of cleaning liquid to a second set of nozzles, the first secondary valve block comprising a first secondary control circuit electrically connected in series with the main control circuit and configured to receive information coming from the main valve block and transmit information to the main valve block, the electrical connection for conveying information between the control unit and the main control circuit and between the main control circuit and the first secondary control circuit being effected by a multiplexed electrical network.

Thus, a sensor cleaning device is obtained having an architecture that is simplified owing to the series connection of the various valve blocks relative to one another. In addition, the use of a multiplexed electrical network for the transmission of information between the control circuits and with the control unit makes it possible to significantly reduce the weight/quantity/total length of cables necessary for the operation of the sensor cleaning device.

Lastly, the use of a multiplexed electrical network allows the centralized routing of several pieces of information in both directions between the main control circuit and one or more secondary control circuits, which allows easy reconfiguration of the sensor cleaning device. To be specific, and in the case where an additional valve block is added, the architecture of the assembly (series connection of the valve blocks and connection by a multiplexed electrical network) allows, thanks to the execution of specific frames, automatic reconfiguration of the sensor cleaning device (i.e. automatic re-addressing of the valves).

According to other optional features of the sensor cleaning device, considered alone or in combination:
each valve block may comprise solenoid valves and an electrical connection support for electrically connecting the solenoid valves to the control circuit;
each secondary valve block may comprise a pull-up resistor and a switch configured to connect or disconnect the pull-up resistor to/from the multiplexed electrical network. This pull-up resistor is used in an addressing method described below;
each secondary valve block may comprise a constant current source and a switch configured to connect or disconnect the current source to/from the multiplexed electrical network. This constant current source is used in an addressing method described below;
each secondary valve block may comprise a shunt connected to the multiplexed electrical network and configured to detect a current intensity passing through it;
each secondary valve block may comprise means for determining the position of the valve block on the multiplexed electrical network as a function of the measured current intensity; and
The sensor cleaning device may comprise at least a second secondary valve block configured to control the delivery of cleaning liquid to a third set of nozzles, the second secondary valve block comprising a second secondary control circuit electrically connected in series with the first secondary control circuit and configured to receive information coming from the first secondary valve block and transmit information to the first secondary valve block, the connection between the first secondary control circuit and the second secondary control circuit being effected by a multiplexed electrical network.

The invention also relates to a method for addressing valve blocks of a sensor cleaning device according to the invention, the addressing method comprising performing the following steps at least once:
First measurement of a current passing through the unaddressed secondary valve blocks in a first configuration,
Second measurement of a current passing through the unaddressed secondary valve blocks in a second configuration,
Determination of the unaddressed secondary valve blocks for which the difference in intensity between the second measurement and the first measurement is less than a first threshold value,
Third measurement of a current passing through the secondary valve blocks for which the difference in intensity between the second measurement and the first measurement is less than a first threshold value, these secondary valve blocks being in a third configuration,
Determination and addressing of the secondary valve block for which the difference in intensity between the third measurement and the first measurement is less than a second threshold value.

According to further optional features of the addressing method, taken individually or in combination:
the steps of the addressing method may take place when the vehicle is started up;
the steps of the addressing method may take place after adding an additional secondary valve block;
the various configurations may be as follows:
The first configuration may correspond to a state in which a pull-up resistor and a constant current source present at each valve block are disconnected from the multiplexed electrical network,
The second configuration may correspond to a state in which the pull-up resistor is connected to the multiplexed electrical network, the constant current source being disconnected from the multiplexed electrical network, and
The third configuration may correspond to a state in which the pull-up resistor and the constant current source are connected to the multiplexed electrical network;
the various intensities may be detected by a shunt connected to the multiplexed electrical network; and
the current passing through the unaddressed secondary valve blocks may be injected at least in part by constant current sources present in the unaddressed secondary valve blocks.

### BRIEF DESCRIPTION OF DRAWINGS

The invention will be better understood on reading the following description, which is given solely by way of example and with reference to the accompanying drawings in which:

FIG. 1 is a schematic view of a motor vehicle sensor cleaning device according to the invention,

FIG. 2 is an exploded view of a valve block according to the invention, and

FIG. 3 depicts the steps of an addressing method according to the invention.

### DETAILED DESCRIPTION OF THE INVENTION

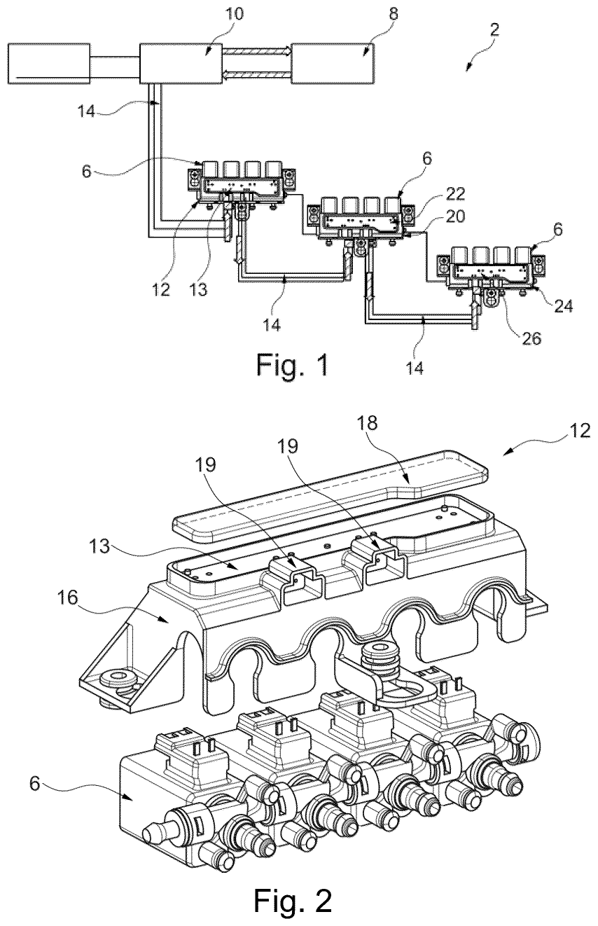

Reference is now made to FIG. 1 illustrating an example of a cleaning device 2 for cleaning sensors (a sensor 8 in FIG. 1) of a motor vehicle, which is intended to be mounted on a motor vehicle. As explained above, this cleaning device ensures the proper functioning of the sensors on board a vehicle, which are exposed to dirt.

In a fairly conventional manner, the cleaning device comprises a tank of cleaning liquid (not shown in the figures) on which a pump is mounted. The pump is mounted in a recess in the tank intended to receive the pump, the tank including a hole through which an intake tube of the pump is mounted, with a seal at the interface between the tank and the pump at the hole to ensure that the assembly is leaktight. As is conventional, the pump is a standard pump comprising a tubular main body for example. This main body may be made up of a pumping first portion and a driving second portion comprising an electric motor. The pumping first portion comprises a liquid intake tube and a liquid discharge tube so that it can receive cleaning liquid from the tank and discharge it at a higher pressure than the intake pressure of the pump. The liquid intake tube may be placed at a free end of the pumping first portion and be coaxial with the main body of the pump, sharing the same axis of revolution. The driving second portion may extend from the pumping first portion in a direction perpendicular to the axis of revolution of the main body.

The driving second portion may be situated above the pumping first portion and comprise an electric motor and, at its free end, a connector making it possible to connect the pump to an electrical power source.

A plurality of cleaning nozzles (not shown in the figures) are situated at the other end of the cleaning device and are intended to be placed in front of the sensors to be cleaned in order to spray pressurized cleaning liquid thereon.

The cleaning device 2 further comprises pipes (or piping) connecting the various members (pump, cleaning nozzle, etc.) to one another to form a fluid distribution circuit.

The cleaning device 2 further comprises several cleaning-liquid valve blocks comprising several valves 6 (four in this instance). The pump is configured to pump the washing liquid from the tank and send it to the valve block and the cleaning nozzles.

The valves 6 of the valve blocks are configured to be fluidically connected respectively to the nozzles (a valve 6 connected to a nozzle for example, it being possible for the number of valves and of nozzles to vary). The valves 6 of each valve block may be fluidically connected to one another and to the other valve blocks. The valves 6 are configured to selectively transmit the pumped washing liquid to the associated cleaning nozzles. The valves 6 are, for example, solenoid valves conventionally used in this type of cleaning device. The valves 6 may be arranged in parallel, meaning that they are all connected to one fluidic channel of the distribution block. This fluidic channel is connected to an inlet of the valve block, which inlet is connected to the pump. An outlet of the valve block is itself closed off by a cap.

Thus, in operation, the activation of the pump makes it possible to transfer the cleaning liquid from the tank to the valve blocks and to the cleaning nozzles.

The valve blocks are modular blocks and so the number of valves 6 may easily be modified to adapt it to suit the number of cleaning nozzles, or to suit a particular configuration of the cleaning device, for example depending on the model of the motor vehicle if the cleaning device 2 is mounted on a motor vehicle.

The various sensors are connected to at least one control unit 10 configured to receive and transmit information coming from the various sensors, in particular information relating to a need to clean said sensors. The control unit 10 may, for example, be formed by a built-in systems interface connected to a power source, typically the battery of the motor vehicle. It could also be formed by an electronic control unit.

The control unit 10 is electrically connected to a main valve block 12 configured to control the delivery of cleaning liquid to a first set of nozzles, the main valve block 12 comprising a main control circuit 13 configured to receive information coming from the control unit 10, typically cleaning information coming from one or more sensors. This information may relate to one or more valves 6 of the main valve block 12. This information is transmitted via a multiplexed electrical network 14, which drastically reduces the amount of electrical wiring on board the vehicle. It may conventionally be a multiplexed electrical network of CAN bus or LIN bus type.

The main valve block 12, like the other valve blocks described below, may comprise, in addition to its constituent valves 6, described above, an electrical connection support 16 for electrically connecting the solenoid valves to the main control circuit 13. This support comprises a first space that is provided for attachment therein of the main control circuit 13 (and that may be covered by a cover 18) and a second space for attachment of the solenoid valves. It may also comprise connectors 19 of the multiplexed electrical network 14, one connector for connecting the main valve block 12 to the control unit 10 and another for connecting the main valve block 12 to a first secondary valve block 20. This configuration is shown in FIG. 2.

As can be seen in FIG. 1, the sensor cleaning device 2 comprises at least a first secondary valve block 20 configured to control the delivery of cleaning liquid to a second set of nozzles, the first secondary valve block 20 comprising a first secondary control circuit 22 electrically connected in series with the main control circuit 13 and configured to receive information coming from the main valve block 12 and transmit information to the main valve block 12, the electrical connection for conveying information between the control unit 10 and the main control circuit 13 and between the main control circuit 13 and the first secondary control circuit 22 being effected by the multiplexed electrical network 14.

In other words, the control unit 10 may transmit and receive information from the main valve block 12 which may itself transmit and receive information from the first secondary valve block 20 (via their respective control circuits). All of this information is transmitted by the multiplexed electrical network 14. The first secondary valve block 20 comprises electrical connections with the main valve block 12 that are identical to those connecting the latter to the control unit 10.

As shown in FIG. 1, it is possible to add a second secondary valve block 24 comprising a second secondary control circuit 26 electrically connected in series with the first secondary control circuit 22 and configured to receive information coming from the first secondary valve block 20 and transmit information to the first secondary valve block 20, the electrical connection for conveying information between the control unit 10 and the main control circuit 13, between the main control circuit 13 and the first secondary control circuit 22 and between the first secondary control circuit 22 and the second secondary control circuit 26 being effected by the multiplexed electrical network 14.

It will therefore be understood that this is an electrical series connection of several valve blocks via a multiplexed electrical network 14, the first of them being connected to the control unit 10. It is therefore possible for the control unit 10 to transmit information to all the valves of the various valve blocks. The main valve block 12 is directly connected to the control unit 10, the secondary valve blocks being connected either to the main valve block 12 (in the case of the first secondary valve block 20) or to another secondary valve block. It is therefore possible to convey information from the control unit 10 to any valve of a valve block.

As explained above, the use of a multiplexed electrical network in the context of this series connection drastically reduces the amount of electrical wiring on board the vehicle.

This also this makes it possible to circulate a piece of information in both directions: It is therefore possible for different pieces of information to reach the main valve block 12 from one or more secondary valve blocks. It is therefore possible to program the various control units and the control unit 10 in order to carry out diagnostic protocols for correct operation of the entire cleaning device or for identifying and addressing the various valves of the various valve blocks, for example when starting up the vehicle, in order to ensure correct addressing of the various valves 6 in order to be certain of activating the valve or valves 6 intended for washing one or more sensors requiring cleaning. This also makes the cleaning device 2 modular because it would be possible to add at least one valve or even an entire valve block and to readdress all the valves of the cleaning device 2 after that.

Preferably, each valve block comprises a pull-up resistor and a switch configured to connect or disconnect the pull-up resistor to/from the multiplexed electrical network. This pull-up resistor may or may not be connected to the multiplexed electrical network in order to be able to measure different intensities passing through the valve block concerned in the context of a valve 6 addressing method, as will be explained below.

Each valve block may also comprise a constant current source and a switch configured to connect or disconnect the current source to/from the multiplexed electrical network. As with the pull-up resistor, the constant current source may or may not be connected to the multiplexed electrical network in order to be able to measure different intensities passing through the valve block concerned in the context of a valve 6 addressing method, as will be explained below.

Each valve block may further comprise a shunt connected to the multiplexed electrical network and configured to detect a current intensity passing through it. This shunt is placed in a control circuit and has the function of providing a piece of information representative of the current intensity passing through it. This intensity measurement will be implemented in the context of an addressing method explained below. Note that the various shunts constitute not only intensity measurement means but also means for protection against overcurrents.

In relation to the various means described above and used in the context of an addressing method, each valve block may comprise means for determining the position of the valve block as a function of the intensity measured.

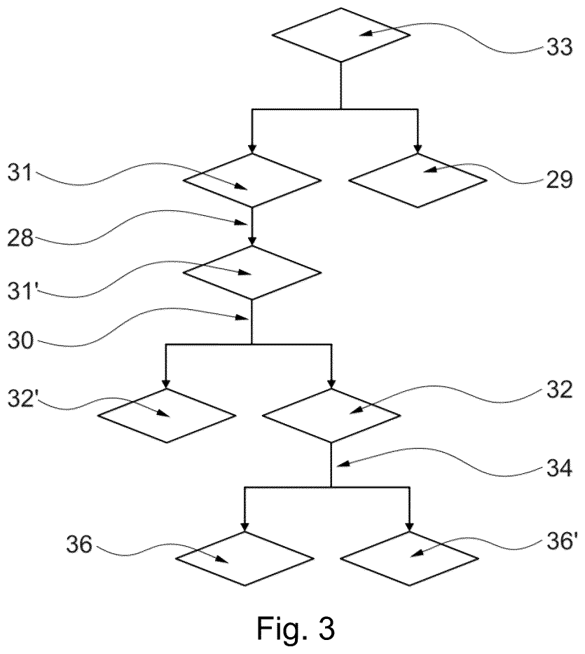

A method for addressing the valves of the valve blocks of the sensor cleaning device 2 will now be described with reference to FIG. 3.

The process is implemented by means of programs stored in memories of the control unit 10 and the control circuits of the valve blocks. It involves identifying the valves of the valve block furthest from the main valve block 12 and not addressed in order to assign them an address. The various intensity values measured and described below may be sent to the control unit 10 from the secondary valve blocks via the multiplexed electrical channel, just as the determination steps described below may take place in this control unit 10.

The process preferably starts when the sensor cleaning device 2 is switched on. It could also start after an additional valve 6 or an additional valve block is added. A current of a first intensity flows through the latter (i.e. the multiplexed electrical network) and the intensity is measured at a time TO at the unaddressed valve blocks, the latter being in a first configuration (step 28 in FIG. 3). This is a reference measurement. The voltage across the shunt may be amplified by an amplifier and integrated by means of a linear or quasi-linear integrator, preferably. Preferably, the first configuration corresponds to a state in which the pull-up resistor and the constant current source present at each valve block are disconnected from the multiplexed electrical network. The latter therefore do not allow additional current to be supplied. No intensity is measured at the secondary valve blocks already addressed (represented by reference 29 in FIG. 3, the unaddressed secondary valve blocks being referenced by the number 31, the sum of the two forming the set of secondary valve blocks 33). Their respective pull-up resistors will be reconnected to the multiplexed electrical network at the end of the addressing method.

At a second time T1, a second measurement of a current passing through the unaddressed secondary valve blocks in a second configuration is carried out on the secondary valve blocks 31′ for which the first measurement of intensity was carried out (step 30 in FIG. 3). The second configuration may correspond to a state in which the pull-up resistor is connected to the multiplexed electrical network, the constant current source being disconnected from the multiplexed electrical network. The intensity measured corresponds to the sum of the reference intensity and the intensity of the current from the pull-up resistor.

The next step consists in determining the unaddressed secondary valve blocks for which the difference in intensity between the second measurement (the sum of the reference intensity and the intensity of the current from the pull-up resistor) and the first measurement (reference intensity) is less than a first threshold value (valve blocks 32 in FIG. 3), for example 1.5 mA. The other secondary valve blocks (referenced 32′ in FIG. 3), for which this difference is greater than the first threshold value, are closest to the main valve block 12 and cannot be the secondary valve block furthest from the main valve block 12 and not addressed. The pull-up resistors thereof are disconnected and no further measurements are taken at the latter.

Next, a third measurement of a current passing through the secondary valve blocks for which the difference in intensity between the second measurement and the first measurement is less than a first threshold value is performed at a time T2, these secondary valve blocks being in a third configuration (step 34 in FIG. 3). This configuration may correspond to a state in which the pull-up resistor and the constant current source of these valve blocks are connected to the multiplexed electrical network. Therefore, the intensity measured corresponds to the sum of the reference intensity, the intensity of the current from the pull-up resistor and the intensity of the current from the constant current source, for example 2 mA.

Finally, the last step consists in determining the secondary valve block for which the difference in intensity between the third measurement (the sum of the reference intensity, the intensity of the current from the pull-up resistor and the intensity of the current from the constant current source) and the first measurement (reference intensity) is less than a second threshold value (secondary valve block 36 in FIG. 3). This valve block is the furthest from the main valve block 12 the valves of which are not addressed. The valves of this valve block may be assigned an address.

The method described above may be repeated as many times as necessary until the valves of all the secondary valve blocks (the secondary valve blocks 36′ in FIG. 3) are fully addressed. Document FR 2 821 453 A1 describes an addressing method related to the method described above.

The secondary valve blocks include an internal marker or internal flag to mark a valve block already addressed. This makes it possible, as explained above, to ensure that the secondary valve blocks already addressed are not involved in the above addressing method.

The above method may comprise two information frames: a first notifying that, during a future frame, the secondary valve blocks must perform an addressing sequence (or self-addressing), and a second in which each secondary valve block detects, by the method described above, whether it is the unaddressed secondary valve block furthest from the main valve block 12.

Note that the sensor cleaning device 2 may comprise addressable secondary valve blocks such as those described above and additional standard and non-addressable valve blocks.

The stored address information constitutes the address of a node of the information network formed by the multiplexed electrical network to which a secondary valve block is connected, this address being, in the control unit 10, recognized as that of the particular function performed by this valve block.

Thus, the invention is particularly advantageous in that it is sufficient for the addresses of the secondary valve blocks to be predefined in the control unit 10 in relation to their location. Storage of an address in a secondary valve block prior to its being fitted is not necessary.

In addition, address programming is an automatic, fast operation which may be performed without detriment each time the installation is switched on. The addresses may then be stored in volatile memories of the secondary valve blocks.

Although the identification method according to the invention is particularly advantageously applicable to the programming of addresses, it can also be applied to the control of secondary valve blocks fitted with their addresses stored in hardware or software.

### LIST OF REFERENCES

2: sensor cleaning device
6: valves
8: sensor
10: control unit
12: main valve block
13: main control circuit
14: multiplexed electrical network
16: electrical connection support
18: cover
19: connectors
20: first secondary valve block
22: first secondary control circuit
24: second secondary valve block
26: second secondary control circuit
28: first measurement of a current passing through the unaddressed secondary valve blocks in a first configuration
29: secondary valve blocks already addressed
30: second measurement of a current passing through the unaddressed secondary valve blocks in a second configuration
31: unaddressed secondary valve blocks
31′: secondary valve blocks for which the first measurement of intensity was carried out
32: unaddressed secondary valve blocks for which the difference in intensity between the second measurement and the first measurement is less than a first threshold value
32′: unaddressed secondary valve blocks for which the difference in intensity between the second measurement and the first measurement is greater than a first threshold value
33: set of secondary valve blocks
34: third measurement of a current passing through the secondary valve blocks for which the difference in intensity between the second measurement and the first measurement is less than a first threshold value, these secondary valve blocks being in a third configuration
36: secondary valve block for which the difference in intensity between the third measurement and the first measurement is less than a second threshold value
36′: secondary valve block for which the difference in intensity between the third measurement and the first measurement is greater than a second threshold value.

What is claimed is:

1. A cleaning device for cleaning motor vehicle sensors intended to be mounted on a motor vehicle, the device comprising at least one tank of cleaning liquid and cleaning nozzles for spraying the cleaning liquid onto sensors to be cleaned
a control unit configured to receive and transmit information coming from the sensors,
a main valve block configured to control the delivery of cleaning liquid to a first set of nozzles, the main valve block including a main control circuit configured to receive information coming from the control unit,
at least a first secondary valve block configured to control the delivery of cleaning liquid to a second set of nozzles, the first secondary valve block including a first secondary control circuit electrically connected in series with the main control circuit and configured to receive information coming from the main valve block and transmit information to the main valve block, the electrical connection for conveying information between the control unit and the main control circuit and between the main control circuit and the first secondary control circuit being effected by a multiplexed electrical network.

2. The cleaning device for cleaning sensors as claimed in claim 1, wherein each valve block includes solenoid valves and an electrical connection support for electrically connecting the solenoid valves to the control circuit.

3. The cleaning device for cleaning sensors as claimed in claim 1, wherein each secondary valve block includes a pull-up resistor and a switch configured to connect or disconnect the pull-up resistor to/from the multiplexed electrical network.

4. The cleaning device for cleaning sensors as claimed in claim 1, wherein each secondary valve block includes a constant current source and a switch configured to connect or disconnect the current source to/from the multiplexed electrical network.

5. The cleaning device for cleaning sensors as claimed in claim 1, wherein each secondary valve block includes a shunt connected to the multiplexed electrical network and configured to detect a current intensity passing through it.

6. The cleaning device for cleaning sensors as claimed in claim 5, wherein each secondary valve block includes means for determining the position of the valve block on the multiplexed electrical network as a function of the measured current intensity.

7. The cleaning device for cleaning sensors as claimed in claim 1, further comprising at least a second secondary valve block configured to control the delivery of cleaning liquid to a third set of nozzles, the second secondary valve block including a second secondary control circuit electrically connected in series with the first secondary control circuit and configured to receive information coming from the first secondary valve block and transmit information to the first secondary valve block, the connection between the first secondary control circuit and the second secondary control circuit being effected by the multiplexed electrical network.

8. A method for addressing valve blocks of a cleaning device for cleaning sensors, the cleaning device including at least one tank of cleaning liquid and cleaning nozzles for spraying the cleaning liquid onto sensors to be cleaned, a control unit configured to control the delivery of cleaning liquid to a first set of nozzles, the main valve block including a main control circuit configured to receive information coming from the control unit, and at least a first secondary valve block configured to control the delivery of cleaning liquid to a second set of nozzles, the first secondary valve block including a first secondary control circuit electrically connected in series with the main control circuit and configured to receive information coming from the main valve block and transmit information to the main valve block, the electrical connection for conveying information between the control unit and the main control circuit and between the main control circuit and the first secondary control circuit being effected by a multiplexed electrical network, the addressing method comprising
taking a first measurement of a current passing through unaddressed secondary valve blocks in a first configuration,
taking a second measurement of a current passing through the unaddressed secondary valve blocks in a second configuration,
determining of the unaddressed secondary valve blocks for which the difference in intensity between the second measurement and the first measurement is less than a first threshold value,
taking a third measurement of a current passing through the secondary valve blocks for which the difference in intensity between the second measurement and the first measurement is less than a first threshold value, these secondary valve blocks being in a third configuration, and;
determining and addressing of the secondary valve blocks for which the difference in intensity between the third measurement and the first measurement is less than a second threshold value.

9. The method as claimed in claim 8, wherein the method occurs on the started up.

10. The method as claimed in claim 8, wherein the method occurs after adding an additional secondary valve block.

11. The method as claimed in claim 8, wherein:
The first configuration corresponds to a state in which a pull-up resistor and a constant current source present at each valve block are disconnected from the multiplexed electrical network,
The second configuration corresponds to a state in which the pull-up resistor is connected to the multiplexed electrical network, the constant current source being disconnected from the multiplexed electrical network, and
The third configuration corresponds to a state in which the pull-up resistor and the constant current source are connected to the multiplexed electrical network.

12. The method as claimed in claim 8, wherein the various intensities are detected by a shunt connected to the multiplexed electrical network.

13. The method as claimed in claim 8, wherein the current passing through the unaddressed secondary valve blocks is injected at least in part by constant current sources present in the unaddressed secondary valve blocks.
